(19) United States
(12) Patent Application Publication
(10) Pub. No.: US 2007/0009178 A1
(43) Pub. Date: Jan. 11, 2007

(54) Image-clustering method and apparatus

(75) Inventors: Kee-eung Kim, Seoul (KR); Min-kyu Park, Seongnam-si (KR); Tae-suh Park, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/435,730

(22) Filed: May 18, 2006

(30) Foreign Application Priority Data
Jul. 7, 2005 (KR) 10-2005-0061346

(51) Int. Cl. G06K 9/36

(52) U.S. Cl. 382/276

(57) ABSTRACT

An apparatus and method for clustering images by inferring a unit of event recognized by a user through the reflection of a user's image-use pattern. The image-clustering apparatus includes an image-storage module for storing a plurality of images, an application module for accessing the stored images according to a user's image-use pattern, a parameter adjustment module for adjusting parameters for clustering the stored images, and an image-clustering module for clustering the stored images by using values corresponding to the use pattern and the adjusted parameters.

### CROSS-REFERENCE TO RELATED APPLICATION

This application is based on and claims priority from Korean Patent Application No. 10-2005-0061346, filed on Jul. 7, 2005, the disclosure of which is incorporated herein by reference.

### BACKGROUND OF THE INVENTION

1. Field of the Invention

The present invention relates to the image clustering, and more particularly to a method and apparatus for clustering images by inferring a unit of event, which is recognized by a user, from a user's image-use pattern.

2. Description of Related Art

Recently, with the development of image-capturing technology and digital image signal processing technology, image-capturing devices, such as digital cameras and camcorders, have become popular, and many people use such devices.

The image-capturing device, unlike a conventional analog camera, can take several hundreds of pictures. A user can categorize the pictures by events, store them in the form of an album, and output them.

As the number of pictures becomes very large, it is difficult for the user to categorize such pictures. Accordingly, methods for automatically categorizing the pictures have been proposed.

For example, pictures can be automatically categorized based on the similarity among pictures, as shown in FIGS. 1A through 1C.

FIG. 1A is a view illustrating pictures categorized based on color, FIG. 1B is a view illustrating pictures categorized based on texture, and FIG. 1C is a view illustrating pictures categorized based on shape or location of a specified object in the pictures.

It is difficult to accurately represent the features of the pictures that a user intends to retrieve through the above-described categorization methods. Also, since a human generally has an inclination to arrange events in the order of their creation time, it is not suitable to categorize the pictures merely based on the specified objects.

In order to address the above problems, an example of clustering pictures based on their creation time is shown in FIGS. 2A through 2C.

FIG. 2A illustrates a calendar-type browser interface method for grouping pictures by month of creation for one year and displaying representative pictures among the pictures photographed every month. FIG. 2B illustrates a method whereby if the pictures, for example, which correspond to March, are selected among the pictures displayed as shown in FIG. 2A, the pictures photographed in March are displayed by day. FIG. 2C illustrates a method whereby photographing times of the pictures are compared with each other and, if an interval between the shooting times of two successive pictures exceeds a predetermined time, the two pictures are categorized into different events.

The clustering method based on the creation time cannot reflect the unit of events recognized by respective users. Specifically, only objective information, such as the shooting time, can be reflected, but a user's image-use pattern, such as a user's picture-use history, a user's explicit event categorization, tag information added by the user, and others, cannot be reflected.

### BRIEF SUMMARY

An aspect of the present invention provides an apparatus and method for clustering images by inferring a unit of event recognized by a user through the reflection of a user's image-use pattern.

According to an aspect of the present invention, there is provided an image-clustering apparatus, including an image-storage module storing a plurality of images, an application module accessing the stored images according to an image-use pattern, a parameter adjustment module adjusting parameters for clustering the stored images, and an image-clustering module clustering the stored images by using values corresponding to the image-use pattern and the adjusted parameters.

According to another aspect of the present invention, there is provided an image-clustering method, including storing a plurality of images, accessing the stored images according to an image-use pattern, adjusting parameters for clustering the stored images, and clustering the stored images by using values corresponding to the image use pattern and the adjusted parameters.

According to another aspect of the present invention, there is provided a computer-readable storage medium encoded with processing instructions for causing a processor to execute the aforementioned image-clustering method.

According to another aspect of the present invention, there is provided an image-clustering apparatus including: an application module accessing stored images according to an image-use pattern; a parameter adjustment module adjusting parameters for clustering the stored images; and an image-clustering module clustering the stored images using values corresponding to the image-use pattern and to adjusted parameters.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIGS. 1A through 1C are views illustrating examples of picture categorization based on a specified object according to the conventional art;

FIGS. 2A through 2C are views illustrating examples of picture clustering based on a temporal order according to the conventional art;

FIGS. 3A through 3D are views illustrating examples of a user's image-use pattern according to an embodiment of the present invention;

FIG. 4 is a block diagram illustrating the construction of an image-clustering apparatus according to an embodiment of the present invention;

FIG. 5 is a flowchart illustrating an image-clustering process according to an embodiment of the present invention; and

FIG. 6 is a view illustrating a user interface according to an embodiment of the present invention.

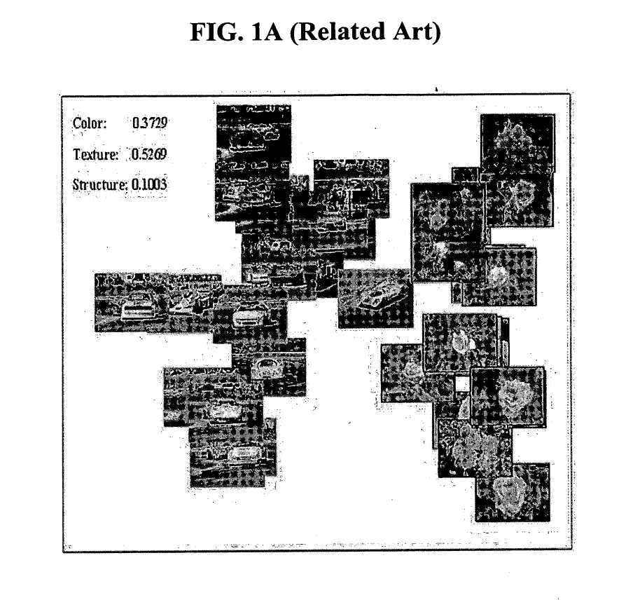

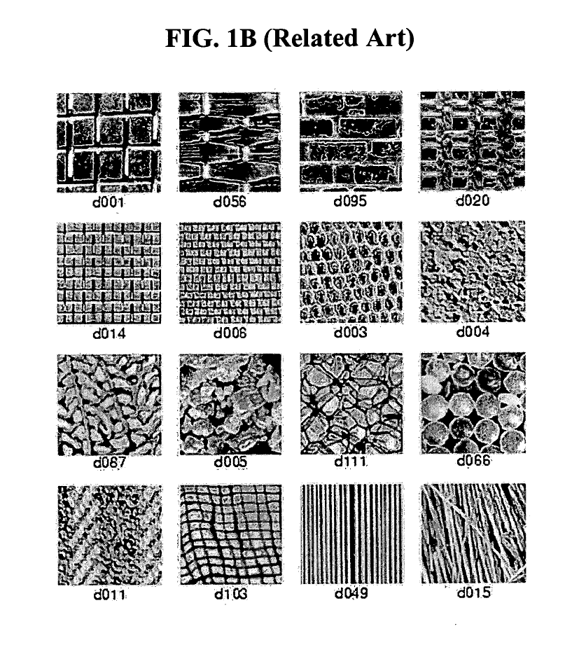

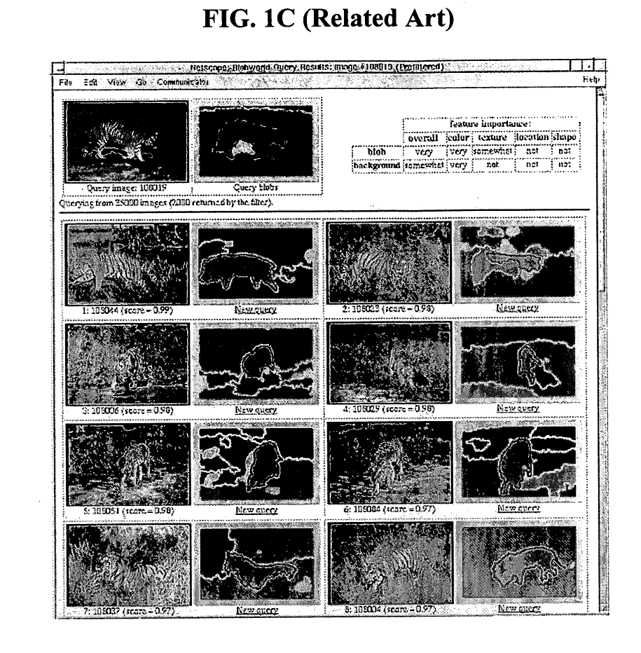

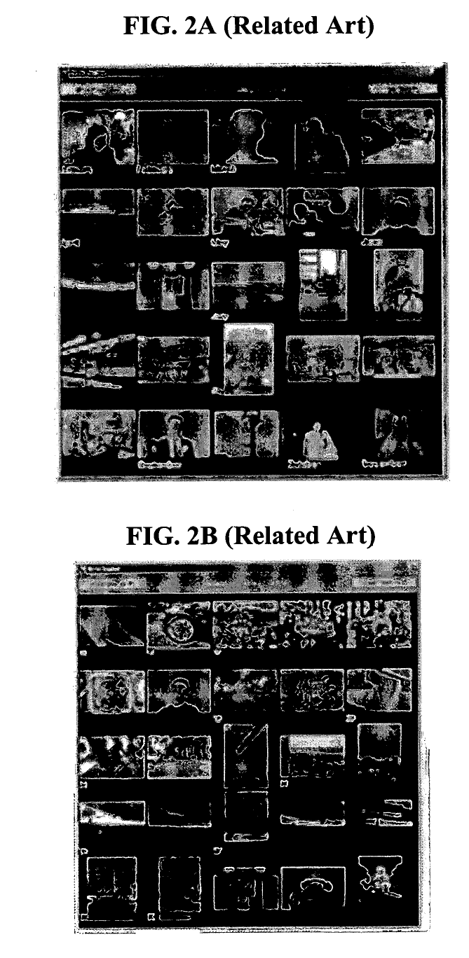

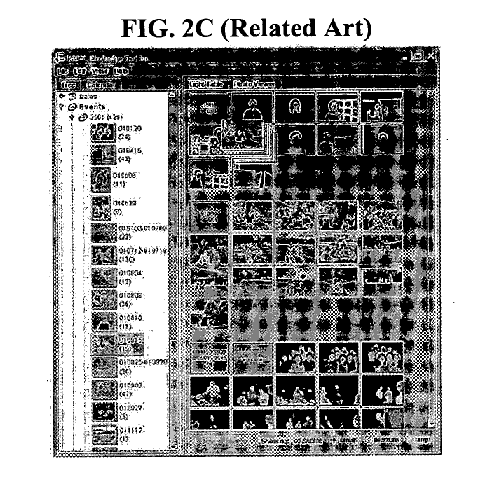

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

Embodiments of the present invention are described hereinafter with reference to flowchart illustrations of user interfaces, methods, and computer program products. It is to be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded into a computer or other programmable data processing apparatus to cause a series of operations to be performed on the computer or other programmable apparatus to produce a computer implemented process such that the instructions that execute on the computer or other programmable apparatus provide operations for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in reverse order, depending upon the functionality involved.

In the following description, a scene photographed by an image-capturing device, such as a digital camera or a camcorder, and stored in a specified format is referred to as an “image”. It is assumed that information on the shooting time of an image is collected by an image-capturing device. For example, most commercial digital cameras store the shooting times according to an international standard EXIF (Exchangeable Image File), when the image is stored in a JPEG format.

Since the following described embodiments of the present invention should infer the unit of an event recognized by the user from the user's image-use pattern, and should put the inference to practical use in an event categorization, it is necessary to define a user's image-use pattern.

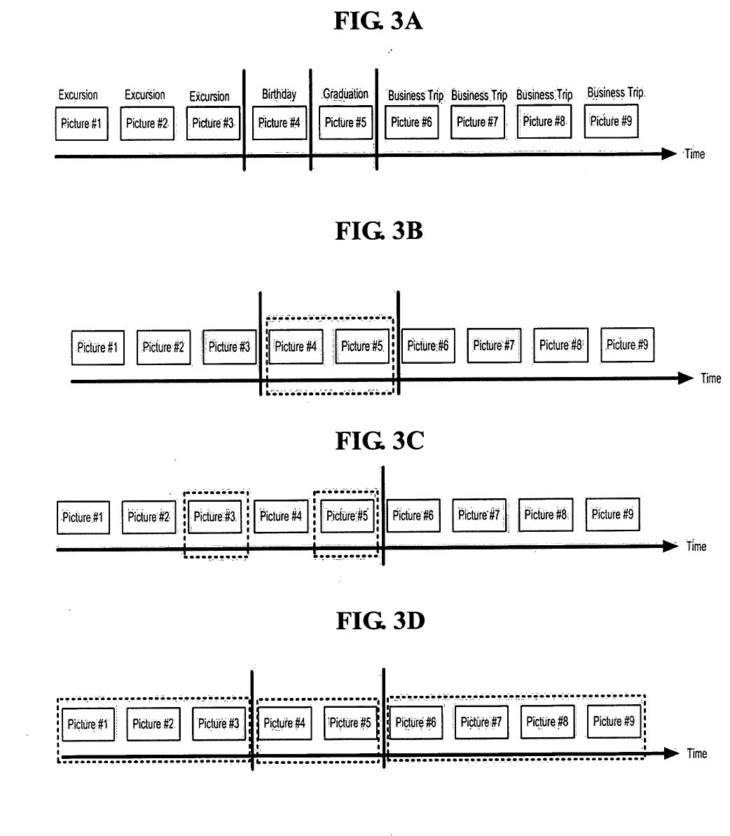

The user's image-use pattern includes i) change of a keyword tag, ii) cluster selection when a slide show, a moving picture, an e-mail, or a photo blog is prepared, and iii) an explicit categorization by the user. FIGS. 3A through 3D show examples of image-use patterns.

FIG. 3A shows an example of the change of the keyword tag among the user's image-use patterns, and represents that the user tends to give the same keyword tag to the same event. More specifically, picture #1 through picture #3 are indexed by a keyword tag of excursion, picture #4 is indexed by a keyword tag of birthday, picture #5 is indexed by a keyword tag of graduation, and picture #6 through picture #9 are indexed by a keyword tag of business trip. Accordingly, the images having the same keyword tag are regarded as the same events through the user's image-use pattern. This tendency was reported by Kuchinsky et al., “Fotofile: A Consumer Multimedia Organization and Retrieval System”,. Proceedings of CHI, 1999.

FIGS. 3B and 3C show examples of the cluster selection among the user's image-use patterns. The user may watch the slide show using picture #4 and picture #5, as shown in FIG. 3B, or transfer picture #3 and picture #5 to the other person via the e-mail, as shown in FIG. 3C. In this case, since the user generally selects a wanted image in the unit of similar event or related event, the user can cluster the selected images by using the user's image-use pattern.

FIG. 3D shows an example of the cluster selection among the user's image-use patterns, in which the user can categorize the events explicitly. More specifically, the user designates picture #1, picture #2, and picture #3 as one event, designates picture #4 and picture #5 as one event, designates picture #6, picture #7, and picture #8 as one event, and designates picture #9 as one event. In this case, the images are clustered in the unit of the event individually designated.

Specifically, the present embodiment utilizes the three image-use patterns of the user, so that the results are reflected on the image clustering.

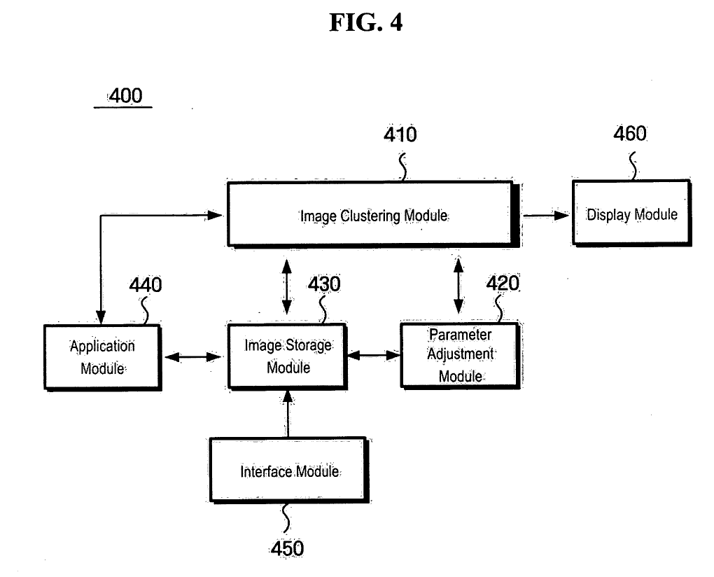

FIG. 4 is a block diagram illustrating the construction of an image-clustering apparatus 400 according to an embodiment of the present invention. The image-clustering apparatus 400 includes an image-clustering module 410, a parameter adjustment module 420, an image-storage module 430, an application module 440, an interface module 450, and a display module 460. The image-clustering module 410, the parameter adjustment module 420, and the application module 440 may be integrated into one module.

The image-clustering apparatus 400 includes devices for categorizing the stored images based on the specified standard and providing the user with the categorized images, such as, by way of non-limiting examples, a digital camera, a camcorder, a personal computer, a notebook computer, and a PDA, and such devices having the functions of these exemplary devices.

The term “module”, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

The image-storage module 430 stores a plurality of images therein, and the stored image may have any format which can be recognized by the image-clustering apparatus 400. The images stored in the image-storage module 430 may be images taken by the image-clustering apparatus 400, or received from an external image providing device through an interface module 450.

Specifically, the interface module 450 may perform serial or parallel communication with other image providing devices to receive an image, or form a cable or wireless network together with other image devices to receive an image. The received image may be transferred to and stored in the image-storage module 430.

The user may explicitly specify the range of an event with respect to the images stored in the image-storage module 430 through the application module 440 so as to cluster the images. For example, if there are one hundred images in the image-storage module 430, image #1 to image #50 are designated as a first event, image #51 to image #70 are designated as a second event, and image #71 to image 100 are designated as a third event.

The information on the range of the designated event is transferred to the parameter adjustment module 420 through the image-clustering module 410, and the parameter adjustment module 420 adjusts parameters based on the transferred information. In this case, the parameter can be seen as a weight value for each element which can be reflected when the image clustering is performed, and includes the change of a keyword tag and the image cluster selection. The parameter may be set through learning.

Also, the user may add the keyword tag to the image stored in the image-storage module 430 through the application module 440, or select a plurality of images so as to prepare a slide show, a moving picture, an e-mail, or a photo blog. That is, the application module 440 may be regarded as an application capable of accessing the images stored in the image-storage module 430.

The results obtained from the operation of the application module 440 are transferred to the image-clustering module 410.

The image-clustering module 410 may cluster the images stored in the image-storage module 430 by using the parameters adjusted by the parameter adjustment module 420 and the processing results received from the application module 440. In this case, the image-clustering module 410 may perform its operation in combination with a conventional algorithm for clustering the images.

The information on the clustering may be stored in various forms. For example, the information may be stored in the image-storage module 430 in the form of a mark-up language such as an extensible markup language (XML), or may be stored in a separate storage area (not shown).

The images clustered by the image-clustering module 410 may be provided to the user through the display module 460. The display module 460 includes a device (e.g., a monitor or liquid crystal display panel) to visually output the clustered images to the user, and a circuit for driving the device.

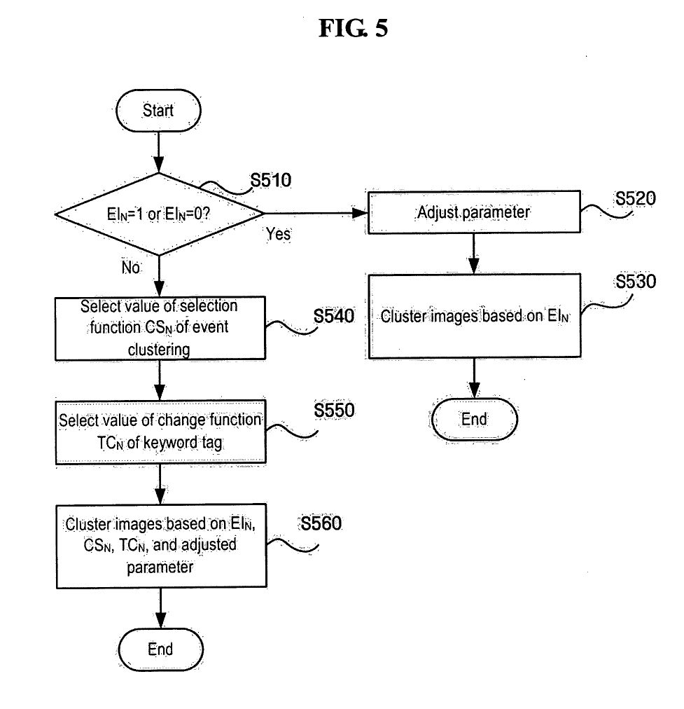

The operation of the image-clustering apparatus shown in FIG. 4 will now be described in detail with concurrent reference to the flowchart of FIG. 5.

When the image-clustering apparatus 400 receives a clustering command for the images stored in the image-storage module 430 from the user, it determines whether to cluster the successive images.

For example, if m images are stored in the image-storage module 430, the image-clustering apparatus determines whether to perform a clustering between the first image and the second image, and then determines whether to perform a clustering between the second image and the third images. FIG. 5 shows the process of determining whether to perform the clustering between the (N−1)-th image and the N-th image.

First, the image-clustering module 410 confirms whether the clustering is explicitly designated by the user with respect to the (N−1)-th image and the N-th image S510.

In this case, the function indicative of “user's explicit designation” is defined as “EI” (explicit input), and EI for the (N−1)-th image and the N-th image is indicated as “EI_{N}”.

The function value of EI_{N} will be defined as follows.
EI_{N}=1 (i)

This refers to a case in which a user has explicitly designated that when the images are arranged in the order of their creation time, the N-th image and the (N−1)-th image are included in the same event.
EI_{N}=0 (ii)

This refers to a case in which a user has explicitly designated that when the images are arranged in the order of their creation time, the N-th image and the (N−1)-th image are included in different events.
EI_{N}=0.5 (iii)

This refers to a case which corresponds to neither of the above two cases.

When the clustering has been explicitly designated by the user in operation S510, that is, EI_{N} is “0” or “1”, the parameter is adjusted S520. Since the user has explicitly designated the clustering, the parameter adjustment is needed. At this time, the parameter is an initial value, and may be preset as an arbitrary value when the image-clustering apparatus 400 is manufactured.

If the parameter is expressed as “w”, the parameter adjustment may be performed by defining an error function E(w) and performing a gradient-descent method for “w”. In this case, the gradient-descent method corresponds to a known algorithm.

According to the gradient-descent method, the value w(n) may be expressed by Equation (1).

$$w ( n ) = w ( n - 1 ) - α \frac{\partial E ( w )}{\partial w} \qquad ( 1 )$$

The error function E(w) may be expressed by Equation (2).

$$E ( w ) = {\sum }_{{EI}_{N} = 0 o r {EI}_{N} = 1} {( {EI}_{N} - \frac{1}{1 + {ⅇ}^{- x}} )}^{2} \qquad ( 2 )$$

In Equation (2),

$$\frac{1}{1 + {ⅇ}^{- x}}$$

is a sigmoid function, which will be described in Equation (4). By differentiating E(w) with respect to “w”, the results are obtained as in Equation (3).

$$\frac{\partial E ( w )}{\partial w} = {\sum }_{{EI}_{N} = 0 or {EI}_{N} = 1} 2 ( {EI}_{N} - \frac{1}{1 + {ⅇ}^{- x}} ) ( - \frac{{ⅇ}^{- x}}{{( 1 + {ⅇ}^{- x} )}^{2}} ) \frac{\partial x}{\partial w} \qquad ( 3 )$$

In this case, the value w(n) means the parameter needed to perform the clustering with respect to the (N−1)-th image and the N-th image, and may be obtained by repeating the process of Equation (1) until the value w(n) becomes equal to the value w(n−1) according to the gradient-descent method. Herein, α is a constant value arbitrarily taken, for example, 0.05.

There may be a plurality of parameters w according to elements reflected when the image clustering is performed. In order to discern the parameters, the parameters w may be expressed as w₁, w₂, w₃, Wₙ.

If the parameter is adjusted in operation S520, the image clustering is performed based on the value of EI_{N} S530. That is, if EI_{N}=1, the images are clustered on condition that the N-th image and the (N−1)-th image are included in the same event. If EI_{N}=0, the images are separated from each other based on a condition that the N-th image and the (N−1)-th image are included in different events.

Meanwhile, in operation S510, if the clustering is not explicitly designated by the user, it is determined that EI_{N}=0.5, and the image-clustering module 410 confirms whether the N-th image and the (N−1)-th image are selected as a cluster when the interested images are used at the production of moving images or the preparation of e-mails S540.

At this time, the function indicative of the cluster selection may be defined as “CS (cross selection)”, CS for the (N−1)-th image and the N-th image is expressed as “CS_{N}”.

The function value of CS_{N} may be defined as follows. However, it is to be understood that the following defined function value is merely exemplary, and that other defined functions are contemplated.
CS_{N}=1 (i)

When the images are arranged in the order of their creation time, and there is a history in that the same cluster has been selected before and after the N-th image, that is, when the i-th image satisfying the condition of (i≦N−1) and the j-th image satisfying the condition of (N≦j) are selected as a cluster, the function value of CS_{N} is set to “1”.
CS_{N}=0 (i)

This refers to a case that does not correspond to the above case.

If the function value of CS_{N} is set in operation S540, the image-clustering module 410 confirms whether the keyword tag is added to the N-th image and the (N−1)-th image S550.

In this case, the function indicative of the keyword tag change is defined as “target changed (TC)”, and TC for the (N−1)-th image and the N-th image will be expressed as “TCN”.

The function value of TC_{N} may be defined as follows. However, it is to be understood that the following defined function value is merely exemplary, and that other defined functions are contemplated.
TC_{N}=1 (i)

This refers to a case in which when the images are arranged in the order of their creation time, the (N−1)-th image and the N-th image have different keyword tags added thereto.
TC_{N}=0 (ii)

This refers to a case in which when the images are arranged in the order of their creation time, the (N−1)-th image and the N-th image have the same keyword tags added thereto.
TC_{N}=0.5 (iii)

This refers to a case that corresponds to neither of the above two cases. In this case, both the two pictures have no keyword tag.

The image clustering is performed based on EI_{N}, CS_{N}, and TC_{N} selected in the operations S510, S540, and S550 and the initially or previously set parameters w S560.

At this time, as an element that is reflected when the image clustering is performed, a conventional algorithm that has been used for image or event clustering may be adopted, in addition to the elements such as EI_{N}, CS_{N}, and TC_{N}.

In performing the image-clustering method in operation S560, whether to cluster or separate the successive images is determined by comparing a specified function value with a reference value, and advantageously by using a sigmoid function.

Specifically, if Equation (4) is effected for a specified x, the successive images may be determined not to be clustered, but to be separated from each other.

$$\frac{1}{1 + {ⅇ}^{- x}} \geq 0.5 \qquad ( 4 )$$

In this case, x may be expressed in the form that includes the conventional algorithms, in addition to the elements such as EI_{N}, CS_{N}, and TC_{N}.

For example, according to U.S. Patent Unexamined Publication No. 2003-0009469, on the assumption that a time gap between the i-th image and the (i+1)-th image is gi when the images are arranged in the order of their creation time, the i-th image and the (i+1)-th image may be separated if the time gap satisfies the condition of Equation (5).

$$log ( {g}_{N} ) \geq K + \frac{1}{2 d + 1} {\sum }_{i = - d}^{d} log ( {g}_{N + i} ) \qquad ( 5 )$$

In this case, K determines the unit of the event, in which as the value K becomes larger, the unit of the event is increased, while as the value K becomes smaller, the unit of the event is decreased.

Thus, in Equation (4), x may be expressed by Equation (6).

$$x = {w}_{1} log ( {g}_{N} ) + {w}_{2} \frac{1}{2 d + 1} {\sum }_{i = - d}^{d} log ( {g}_{N + i} ) + {w}_{3} {CS}_{N} + {w}_{4} {TS}_{N} + {w}_{5} \qquad ( 6 )$$

In this case, w₁ through w₅ indicate parameter values according to an embodiment of the present invention, and each parameter value is a value set through operation S520, or a previously set value as an initial value when the image-clustering apparatus 400 is manufactured.

For example, the value w₁ may be expressed by Equation (7) by applying Equation (3) thereto.

$$\frac{\partial E ( w )}{\partial {w}_{1}} = α {\sum }_{{EI}_{N} = 0 or {EI}_{N} = 1} 2 ( {EI}_{N} - \frac{1}{1 + {ⅇ}^{- x}} ) ( - \frac{{ⅇ}^{- x}}{{( 1 + {ⅇ}^{- x} )}^{2}} ) log ( {g}_{N} ) \qquad ( 7 )$$

As an alternative, when the image cluster is separated by events, the image cluster is separated into two clusters by clustering time intervals of image photographing, and the cluster corresponding to the wider time interval is processed as a boundary of the event, as disclosed in U.S. Pat. No. 6,606,411.

Here, on the assumption that P₁ is a probability that the image is contained in an inter-event cluster and P₂ is a probability that the image is contained in an intra-event cluster, the value x may be expressed as Equation (8) by applying Equation (4) thereto.
x=w₁P₁(g_{N})+w₂p₂(g_{N})+w₃CS_{N}+w₄TS_{N}+w₅ (8)

According to U.S. Patent Publication No. 2003-0009469 and U.S. Pat. No. 6,606,411, the user's picture use history and the event explicitly categorized by the user are not reflected in the image clustering. In the present embodiment of the present invention, the user's image-use pattern can be reflected in the image clustering.

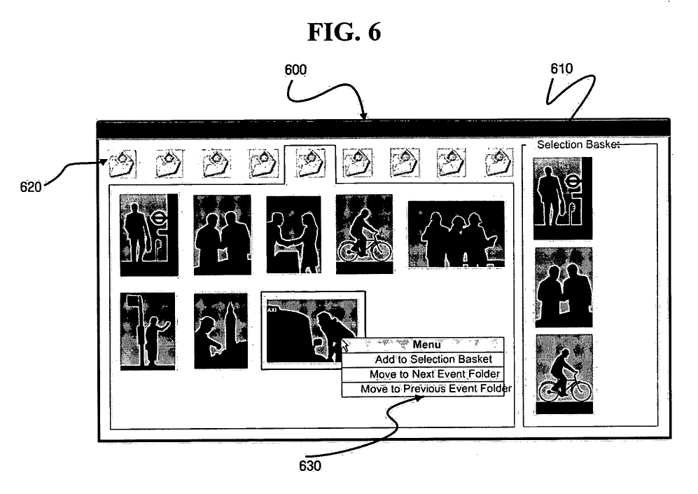

FIG. 6 is a view illustrating a user interface according to an embodiment of the present invention. The user interface of FIG. 6 is described with concurrent reference to FIG. 4. A user interface 600 can provide images clustered by the image-clustering module 410 to the user through the display module 460.

The images clustered by the image-clustering module 410 are provided in the form of a virtual folder 620 as one cluster, and the user interface 600 provides several clusters created by the above process to the user. Each cluster can display a certain image among the images contained in its cluster on its cluster surface as a representative image.

Certain images may be selected among the images contained in each cluster, and be transferred to a selection basket 610. The transferred images may be transmitted by a user via e-mail, or transferred to a blog. Also, a slide show may be performed by using the images contained in the selection basket 610. That is, the user's image-use pattern may be reflected through the images contained in the selection basket 610.

Also, the images may be moved from one cluster to other cluster by an image moving menu 630. The user can explicitly categorize the range of events to cluster the images.

Comparing the performance obtained according to an embodiment of the present invention with that of the conventional image clustering algorithm by experiments, it can be shown that the clustering precision is remarkably improved.

In the experiments, personal pictures were received from three persons (user #1, user #2, and user #3), which includes 716 pictures of user #1 photographed during 1012 days, 1024 pictures of user #2 photographed during 1204 days, and 207 pictures of user #3 photographed during 509 days. Letting the respective users directly designate the ranges of events, recall, precision, and F-measure, results of the algorithm were measured.

The recall is a ratio of the events found by the algorithm among the categories of the events explicitly designated by the user, the precision is a ratio of the events explicitly designated by the user among the categories of the events computed by the algorithm, and the F-Measure is a geometric mean of the recall and the precision, which is a measure generally used to compare the performances of information retrieval algorithms. If the algorithm computes all pictures as separate events, the recall becomes 1.0, but the precision becomes lowered greatly.

If the algorithm computes all pictures as one event, the precision becomes 1.0, but the recall becomes lowered greatly. Consequently, when both the recall and the precision are high, a good performance can be obtained. To this end, the F-measure which is the geometric mean between the recall and the precision has been widely used as a performance comparing measure.

In Tables (1) to (3) below, the conventional art 1 corresponds to the technique disclosed in U.S. Patent Unexamined Publication No. 2003-0009469, and the conventional art 2 corresponds to the technique disclosed in U.S. Pat. No. 6,606,411.

TABLE (1)
User #1

| | Recall | Precision | F-Measure |
|---|---|---|---|
| Conventional Art 1 | 1.0 | 0.47 | 0.64 |
| Conventional Art 2 | 1.0 | 1.0 | 1.0 |
| Embodiment of | 1.0 | 1.0 | 1.0 |
| Present Invention | | | |

TABLE (2)
User #2

| | Recall | Precision | F-Measure |
|---|---|---|---|
| Conventional Art 1 | 0.91 | 0.43 | 0.59 |
| Conventional Art 2 | 1.0 | 0.21 | 0.35 |
| Embodiment of | 0.78 | 0.80 | 0.79 |
| Present Invention | | | |

TABLE (3)
User #3

| | Recall | Precision | F-Measure |
|---|---|---|---|
| Conventional Art 1 | 0.86 | 0.83 | 0.85 |
| Conventional Art 2 | 0.97 | 0.58 | 0.73 |
| Embodiment of | 0.93 | 0.93 | 0.93 |
| Present Invention | | | |

According to the above-described embodiments of the present invention, since the user's image-use pattern is reflected, the image clustering that possibly corresponds to the event recognized by the user can be provided.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An image-clustering apparatus comprising:
an image-storage module storing a plurality of images;
an application module accessing the stored images according to an image-use pattern;
a parameter adjustment module adjusting parameters for clustering the stored images; and
an image-clustering module clustering the stored images using values corresponding to the image-use pattern and adjusted parameters.

2. The image-clustering apparatus of claim 1, wherein, when a range of an event for the stored images is explicitly designated by a user, the parameter adjustment module adjusts the parameter based on the designated range.

3. The image-clustering apparatus of claim 1, wherein the use pattern relates to whether keyword tags have been added to the stored images.

4. The image-clustering apparatus of claim 3, wherein whether keyword tags have been added includes a first case in which an (N−1)-th image and an N-th image have the different keyword tags added thereto, a second case in which the (N−1)-th image and the N-th image have the same keyword tags added thereto, and a third case in which the (N−1)-th image and the N-th image do not have keyword tags added thereto.

5. The image-clustering apparatus of claim 1, wherein the use pattern relates to whether a cluster has been selected for the stored images.

6. The image-clustering apparatus of claim 5, wherein whether a cluster has been selected includes a first case in which there-is a history in that the same cluster has been selected before and after an N-th image, and a second case in which there is no history.

7. The image-clustering apparatus of claim 1, wherein the use pattern comprises a case in which a range of an event for the stored images is not explicitly designated by a user.

8. The image-clustering apparatus of claim 1, wherein the parameter is adjusted by a gradient-descent method.

9. The image-clustering apparatus of claim 8, wherein a function used in the gradient-descent method is expressed as an error function.

10. The image-clustering apparatus of claim 9, wherein the error function uses a sigmoid function.

11. The image-clustering apparatus of claim 1, further comprising an interface module receiving images and storing the images in the image-storage module.

12. The image-clustering apparatus of claim 1, further comprising a display module outputting the images clustered by the image-clustering module.

13. The image-clustering apparatus of claim 12, wherein the display module comprises a plurality of clusters in which the clustered images are formed in a virtual folder, and a selection basket reflecting the image-use pattern for the images contained in the cluster.

14. An image-clustering method comprising:
storing a plurality of images;
accessing the stored images according to an image-use pattern;
adjusting parameters for clustering the stored images; and
clustering the stored images using values corresponding to the image-use pattern and adjusted parameters.

15. The image-clustering method of claim 14, wherein, when a range of an event for the stored images is explicitly designated by a user, the adjusting parameters comprises adjusting the parameter based on the designated range.

16. The image-clustering method of claim 14, wherein the use pattern relates to whether keyword tags have been added to the stored images.

17. The image-clustering method of claim 16, wherein whether keyword tags have been added includes a first case in which an (N−1)-th image and an N-th image have the different keyword tags added thereto, a second case in which the (N−1)-th image and the N-th image have the same keyword tags added thereto, and a third case in which the (N−1)-th image and the N-th image do have keyword tags added thereto.

18. The image-clustering method of claim 14, wherein the use pattern relates to whether a cluster has been selected for the stored images.

19. The image-clustering method of claim 18, wherein whether a cluster has been selected includes a first case in which there is a history in that the same cluster has been selected before and after an N-th image, and a second case in which there is no history.

20. The image-clustering method of claim 14, wherein the use pattern comprises a case in which a range of an event for the stored images is not explicitly designated by a user.

21. The image-clustering method of claim 14, wherein the parameter is adjusted by a gradient-descent method.

22. The-image-clustering method of claim 21, wherein a function used in the gradient-descent method is expressed as an error function.

23. The image-clustering method of claim 22, wherein the error function uses a sigmoid function.

24. The image-clustering method of claim 14, wherein the storing includes receiving and storing images.

25. The image-clustering method of claim 14, further comprising outputting the images clustered by the image-clustering module.

26. The image-clustering method of claim 25, wherein the outputting comprises providing a user interface that includes a plurality of clusters in which the clustered images are formed in a virtual folder, and a selection basket for reflecting the user's image-use pattern for the images contained in the cluster.

27. A computer-readable storage medium encoded with processing instructions for causing a processor to execute an image-clustering method, the method comprising:
storing a plurality of images;
accessing the stored images according to an image-use pattern;
adjusting parameters for clustering the stored images; and
clustering the stored images using values corresponding to the image-use pattern and adjusted parameters.

28. An image-clustering apparatus comprising:
an application module accessing stored images according to an image-use pattern;
a parameter adjustment module adjusting parameters for clustering the stored images; and
an image-clustering module clustering the stored images using values corresponding to the image-use pattern and to adjusted parameters.

29. The apparatus of claim 28, wherein the values corresponding to the adjusted parameters are derived from:
a cross-selection function relating to a use history of the stored images; and
a target changed function relating to an identity of keyword tags added to the stored images and to a presence of keyword tags added to the stored images.

30. The apparatus of claim 28, wherein the image-use pattern comprises: a change of a keyword tag; a cluster selection when a slide show, a moving picture, an e-mail, or a photo blog is prepared; and an explicit categorization input by a user.
